(19) United States
(12) Patent Application Publication
(10) Pub. No.: US 2017/0190149 A1
(43) Pub. Date: Jul. 6, 2017

(54) CARBON FIBER WRAPPED STRUCTURAL COMPONENTS FOR A MACHINE

(71) Applicant: Caterpillar Inc., Peoria, IL (US)

(72) Inventors: Marion Grant, Princeville, IL (US); Thomas Garland, East Peoria, IL (US); Joseph Spanier, Metamora, IL (US); John Unser, Dunlap, IL (US)

(73) Assignee: Caterpillar Inc., Peoria, IL (US)

(21) Appl. No.: 14/987,368

(22) Filed: Jan. 4, 2016

(51) Int. Cl. B32B 15/14; B32B 15/18; D06M 11/83; D06M 15/59; E02F 9/16; B62D 29/00; B62D 21/15; E02F 3/32; E02F 3/36; B32B 5/02; B62D 21/18

(52) U.S. Cl. CPC B32B 15/14; B32B 5/024; B32B 15/18; D06M 11/83; D06M 15/59; B62D 21/186; B62D 29/004; B62D 21/15; E02F 3/32; E02F 3/3604; E02F 9/16; B32B 2255/02; B32B 2255/26; B32B 2255/205; B32B 2262/106; B32B 2307/558; D06M 2101/40

(57) ABSTRACT

A component for a machine is disclosed. The component may include an interior frame, a protruding member extending from the interior frame, and a carbon fiber wrapped over the interior frame and around the protruding member. A method of manufacturing a component for a machine is also disclosed. The method may include supplying an interior frame with a protruding member extending from the interior frame. The method may further include wrapping a carbon fiber around the interior frame and the protruding member, and curing the carbon fiber to the interior frame.

### FIELD OF THE DISCLOSURE

The present disclosure generally relates to machines and, more particularly, relates to structural components for machines and methods for manufacturing same.

### BACKGROUND OF THE DISCLOSURE

Machines, such as excavators, tractors, dozers, loaders, mining trucks, and the like, include many structural components that are made entirely out of steel. Although strong and durable, steel components may add to an overall weight of a machine. Accordingly, there exists a need to reduce a weight of the structural components of the machine.

Recently, three-dimensional (3D) additive manufacturing methods have been explored for fabrication of structural components for machines. In 3D additive manufacturing, a 3D printer uses a metallic powder deposited in successive layers to build a structural component. However, the metallic powder is significantly more expensive than plated steel. Furthermore, to 3D print the structural component, a considerably larger quantity of the expensive metallic powder is required than an amount of powder that is actually incorporated into the finished part.

A body structure is disclosed in Japanese Patent No. JP2012131309A, entitled, “Vehicle Body Structure.” The body structure of JP2012131309A is composed of a pipe that is a substantially straight cylinder with a circular cross-section. The pipe of JP2012131309A is completely formed using a filament winding method.

While effective, there is still a need for structural components having reduced weight, high tensile strength and impact resistance, as well as the ability to attach to other components of the machine after fabrication.

### SUMMARY OF THE DISCLOSURE

In accordance with one embodiment, a structural component for a machine is disclosed. The component may include an interior frame, a protruding member extending from the interior frame, and a carbon fiber wrapped over the interior frame and around the protruding member.

In accordance with another embodiment, a method of manufacturing a component for a machine is disclosed. The method may include supplying an interior frame with a protruding member extending from the interior frame. The method may further include wrapping a carbon fiber around the interior frame and the protruding member, and curing the carbon fiber to the interior frame.

In accordance with another embodiment, a machine is disclosed. The machine may include a machine frame, a ground engaging member supporting the machine frame, a prime mover supported by the machine frame, and at least one structural component forming part of the machine, the structural component including an interior frame having a tubular wall composed of steel, a protruding member extending from the interior frame and configured for attachment to another component of the machine, and a carbon fiber wrapped around the interior frame and the protruding member.

These and other aspects and features will become more readily apparent upon reading the following detailed description when taken in conjunction with the accompanying drawings. In addition, although various features are disclosed in relation to specific exemplary embodiments, it is understood that the various features may be combined with each other, or used alone, with any of the various exemplary embodiments without departing from the scope of the disclosure.

### BRIEF DESCRIPTION OF THE DRAWINGS

FIG. 1 is a side view of a machine, in accordance with one embodiment of the present disclosure;

FIG. 2 is a perspective view of an interior frame and a protruding member for a component of the machine of FIG. 1, in accordance with another embodiment;

FIG. 3 is a perspective view of a finished component with the interior frame and the protruding member of FIG. 2 wrapped in a carbon fiber, in accordance with another embodiment;

FIG. 4 is a perspective view of a tow of carbon fiber used to form the component of FIG. 3, in accordance with another embodiment;

FIG. 5 is a perspective view of a carbon fiber wrapping machine used to form the component of FIG. 3, in accordance with another embodiment;

FIG. 6 is a perspective view of a sleeve of carbon fiber used to form the component of FIG. 3, in accordance with another embodiment;

FIG. 7 is a cross-sectional view of a component with a protective layer, in accordance with another embodiment;

FIG. 8 is a perspective view of a sheathing, in accordance with another embodiment;

FIG. 9 is a cross-sectional view of a component with multiple protective layers, in accordance with another embodiment; and

FIG. 10 is a flowchart illustrating an example process for manufacturing a component for a machine, in accordance with another embodiment.

While the present disclosure is susceptible to various modifications and alternative constructions, certain illustrative embodiments thereof will be shown and described below in detail. The disclosure is not limited to the specific embodiments disclosed, but instead includes all modifications, alternative constructions, and equivalents thereof.

### DETAILED DESCRIPTION

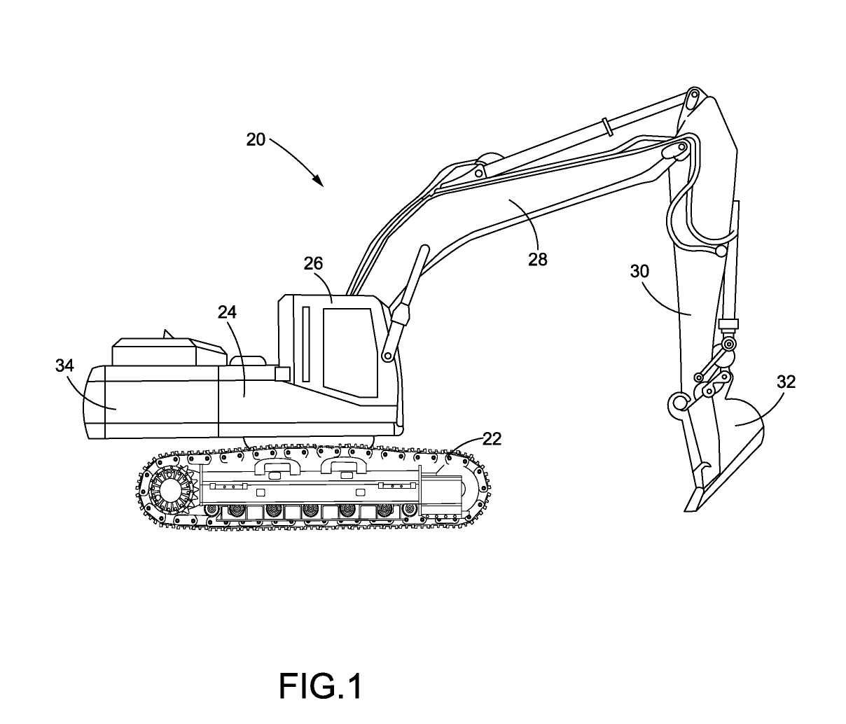

Referring now to the drawings, and with specific reference to FIG. 1, a machine 20 is shown in accordance with certain embodiments of the present disclosure. It is to be understood that although the machine 20 is illustrated as an excavator, the machine 20 may be of any other type. As used herein, the term “machine” refers to a mobile machine that performs a driven operation involving physical movement associated with a particular industry, such as, earthmoving, construction, landscaping, mining, forestry, agriculture, transportation, etc.

Non-limiting examples of machines include commercial and industrial machines, such as earth-moving vehicles, excavators, tractors, dozers, loaders, motor graders, backhoes, mining vehicles, on-highway vehicles, trains, agricultural equipment, material handling equipment, and other types of machines that operate in a work environment. It is to be understood that the machine 20 is shown primarily for illustrative purposes to assist in disclosing features of various embodiments, and that FIG. 1 does not depict all of the components of a machine.

The machine 20 may include a set of ground engaging members 22 that support a machine frame 24. Although the ground engaging members 22 are shown as tracks, the members 22 may be wheels or of any other type. The machine frame 24 may support an operator cab 26, linkages, such as a boom 28 and a stick 30, and a work implement or tool 32. An engine 34 or other power source may be operatively configured to drive the ground engaging members 22, the boom 28, the stick 30, and/or the work tool 32.

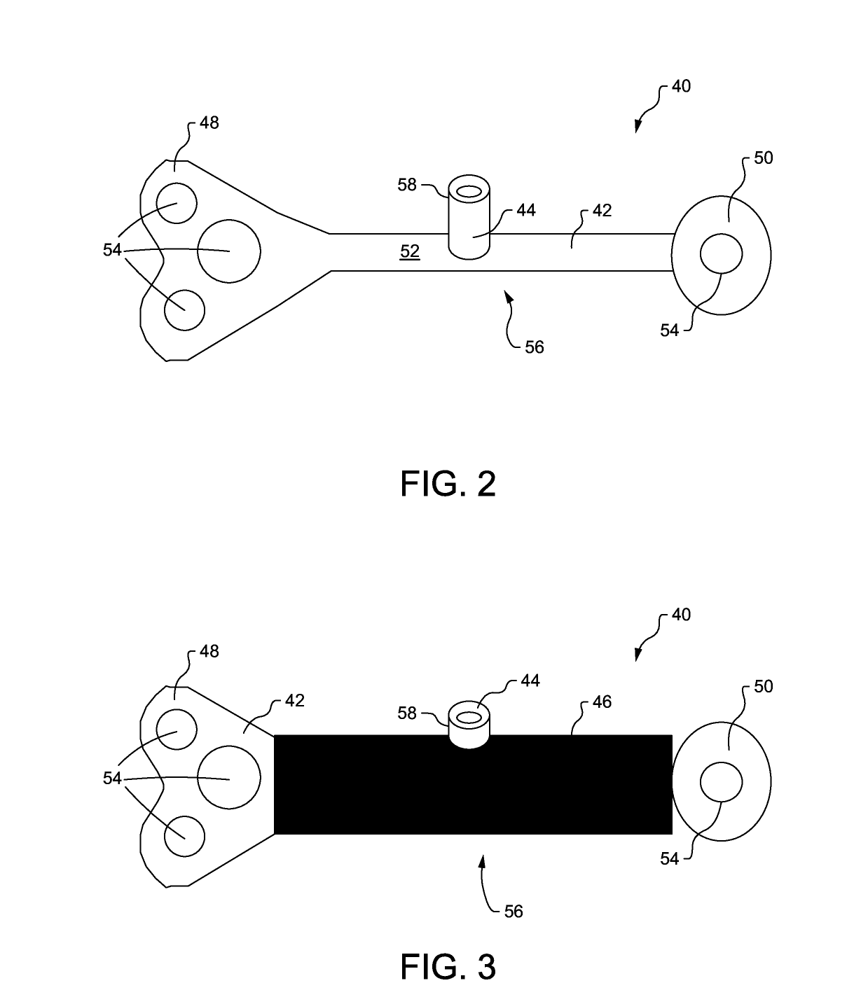

Referring now to FIGS. 2 and 3, with continued reference to FIG. 1, a structural component 40 of the machine 20 is shown, in accordance with an embodiment of the present disclosure. At least one component 40 may be used to comprise the frame 24, the operator cab 26, the boom 28, the stick 30, other linkages, lift arms, levers, the work tool 32, brackets, a hydraulic tank, or any other component of the machine 20. The component 40 may include an interior frame 42, a protruding member 44 extending from the interior frame 42, and a carbon fiber 46 wrapped around the interior frame 42 and the protruding member 44.

Extending from a first end 48 to a second end 50, the interior frame 42 may include a tubular structure 52. For example, the tubular structure 52 may comprise a tube including a substantially thin wall, although other configurations for the interior frame 42 may be used. A cross-section of the tubular structure 52 may be circular, oval, triangular, square, rectangular, hexagonal, octagonal, polygonal, or any other shape.

In one example, the first end 48 and the second end 50 of the interior frame 42 may be configured for attachment to other components of the machine 20. Each of the first end 48 and the second end 50 may be attached to the other components of the machine 20, such as via bolting, welding, and the like. For instance, the first end 48 and the second end 50 may be used in pivot joints or other types of joints. In this example, each of the first end 48 and the second end 50 may include bores 54 for receiving bolts or other means of attachment. However, other attachment features than bores 54 may be used. Furthermore, the interior frame 42 may not include attachment features on the first end 48 and/or the second end 50.

The interior frame 42 may be composed of steel. However, aluminum, titanium, other metallic materials, and non-metallic materials may also be used for the interior frame 42. For example, the wall of the interior frame 42 may have a thickness between an inclusive range of approximately three millimeters to six millimeters, although other thicknesses may be used. Compared to prior art steel components having a thickness of ten millimeters to fifteen millimeters, the thickness of the wall of the interior frame 42 in accordance with the present invention may be reduced to about one third of that of the prior art. In so doing, a weight of the component 40 and a weight of the machine 20 may be significantly reduced as well.

Protruding outward from the interior frame 42, the protruding member 44 may be configured for attachment to other components of the machine 20. For instance, the protruding member 44 may comprise a boss, a bushing, or any other type of feature for attachment to another component of the machine 20. In one example, the protruding member 44 may extend radially outward from the tubular structure 52. Although shown, in FIGS. 2-3, as positioned proximate a middle 56 of the interior frame 42, the protruding member 44 may be positioned anywhere along the interior frame 42. Furthermore, in other embodiments, the component 40 may not include a protruding member 44.

The protruding member 44 may be composed of steel, aluminum, titanium, other metallic materials, and non-metallic materials. For example, the protruding member 44 may be composed of a same material as the interior frame 42, although the protruding member 44 may also be composed of a different material than the interior frame 42. Furthermore, the protruding member 44 may be formed as part of the interior frame 42 at a same time the interior frame 42 is being formed, such as during casting or any other fabrication method. In another example, the protruding member 44 may be attached to the interior frame 42, such as via welding, brazing, soldering, and the like, after each of the protruding member 44 and the interior frame 42 has been formed separately.

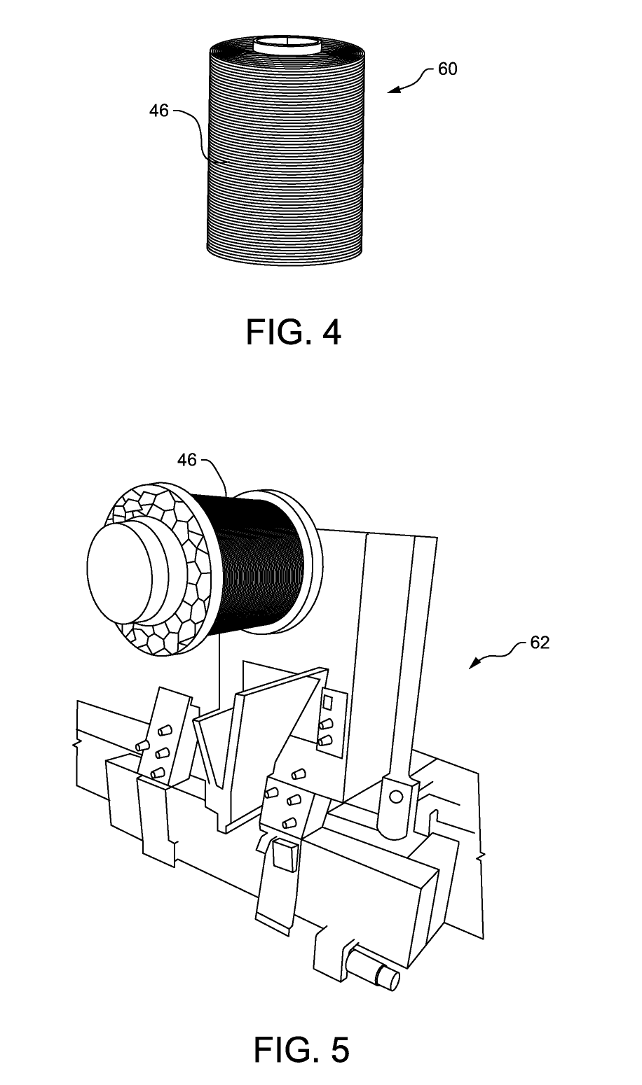

As shown in FIG. 3, the carbon fiber 46 may be wrapped over the interior frame 42 and around the protruding member 44 such that the first end 48, the second end 50, and an end 58 of the protruding member 44 are uncovered or exposed for attachment to other components of the machine 20. The carbon fiber 46 may add reinforcement, tensile strength, and stiffness to the interior frame 42 without adding substantial weight to the component 40. Moreover, the carbon fiber 46 may consist of fibers composed mostly of carbon atoms and bundled together to form a single, continuous filament or a tow 60 of carbon fiber 46, as shown in FIG. 4. For example, a diameter of the single filament of carbon fiber 46 may be ten microns to twenty microns. However, other diameters for the single filament of carbon fiber 46 may be used. Furthermore, other types of fiber besides carbon fiber may be used in addition to or instead of carbon fiber 46.

A carbon fiber wrapping machine 62, as shown in FIG. 5, may be used to wrap the carbon fiber 46 around the interior frame 42 and the protruding member 44. In one example, the wrapping machine 62 may wind the single filament of carbon fiber 46 around the interior frame 42 and the protruding member 44 without covering the ends 48, 50, 58. By leaving the ends 48, 50, 58 exposed, the component 40 may be attached to another component after being wrapped in carbon fiber. However, the component 40 may also be attached to the other component(s) first and the entire configuration may be subsequently wrapped, as well. An overall thickness of the carbon fiber 46 may depend on the type of component 40 being manufactured.

In another example, the wrapping machine 62 may wind multiple filaments of carbon fiber 46 at a same time around the interior frame 42 and the protruding member 44. For instance, the wrapping machine 62 may be configured to interlace the multiple filaments of carbon fiber 46, such as via weaving, braiding, or other processes, as the interior frame 42 and the protruding member 44 are being wrapped. More specifically, the wrapping machine 62 may interlace the multiple filaments of carbon fiber together as the wrapping machine 62 winds the carbon fiber 46 around the interior frame 42 and the protruding member 44.

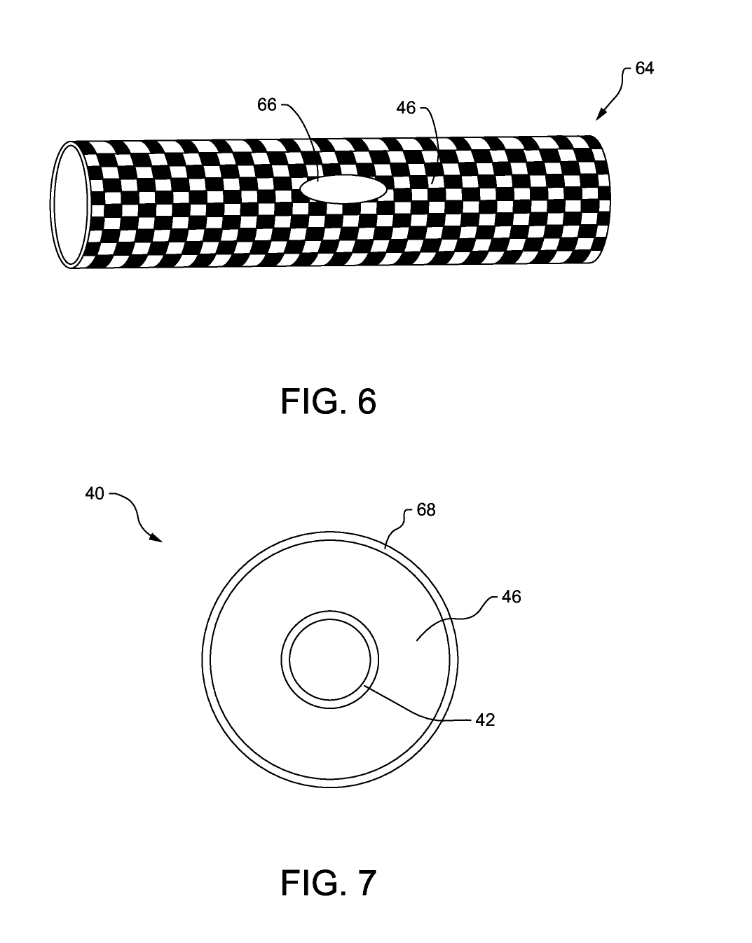

In yet another example, the carbon fiber 46 may be provided in a pre-woven arrangement, such as a sleeve 64, shown in FIG. 6. The sleeve 64 may comprise filaments of the carbon fiber 46 interlaced together, such as via weaving, braiding, or other processes, to form a layer of carbon fiber 46. The sleeve 64 of carbon fiber 46 may be applied around the interior frame 42 and the protruding member 44 as one cohesive layer. A thickness of the sleeve 64 may depend on the type of component 40 being manufactured.

In order for the interior frame 42 to fit within the sleeve 64, the sleeve 64 may have to accommodate for the ends 48, 50 and the protruding member 44, which may be larger than a diameter of the tubular structure 52. For example, the sleeve 64 may be compressed in an axial direction such that a diameter of the sleeve 64 increases. The sleeve 64 may then be placed over the interior frame 42 and the protruding member 44. Once positioned over the interior frame 42, the sleeve 64 may be stretched out such that the diameter of the sleeve 64 decreases and the sleeve 64 is fit tightly around the interior frame 42. In addition, the sleeve 64 may have features, such as an opening 66, to accommodate the exposure of the end 58 of the protruding member 44. However, other configurations for the sleeve 64 and other configurations for wrapping of the carbon fiber 46 may be used.

Furthermore, the carbon fiber 46 may be fused to the interior frame 42, such as via a curing process. A hardener and resin, such as in an epoxy, may be applied to the carbon fiber 46. Examples of resins may include, but not be limited to, vinyl ester and urethane. The resin may be applied to the carbon fiber 46 as it is being wrapped around the interior frame 42. For example, the resin may be applied to the filament(s) of carbon fiber 46 as it is being wound around the interior frame 42.

In another example, the resin may be applied after one layer of carbon fiber 46 has been wrapped around the interior frame 42 and onto each subsequent layer thereafter. There may also be an application of the resin only after all of the carbon fiber 46 has been wrapped around the interior frame 42. Heat, radiation, ultraviolet radiation, and the like may be used to cure the carbon fiber 46 to the interior frame 42 after application of the resin to the carbon fiber 46. However, other curing processes may be used.

Referring now to FIG. 7, with continued reference to FIGS. 1-6, the component 40 may further include a protective layer 68 around the carbon fiber 46. The protective layer 68 may provide increased protection and impact resistance to the component 40. Encasing the carbon fiber 46 and the interior frame 42, the protective layer 68 may be composed of nylon, steel, or other suitable materials. The protective layer 68 may have a thickness between an inclusive range of approximately one millimeters to two millimeters, although other thicknesses may be used. In one example, the protective layer 68 may be three-dimensionally printed over the carbon fiber 46 using a three-dimensional printer and powdered material.

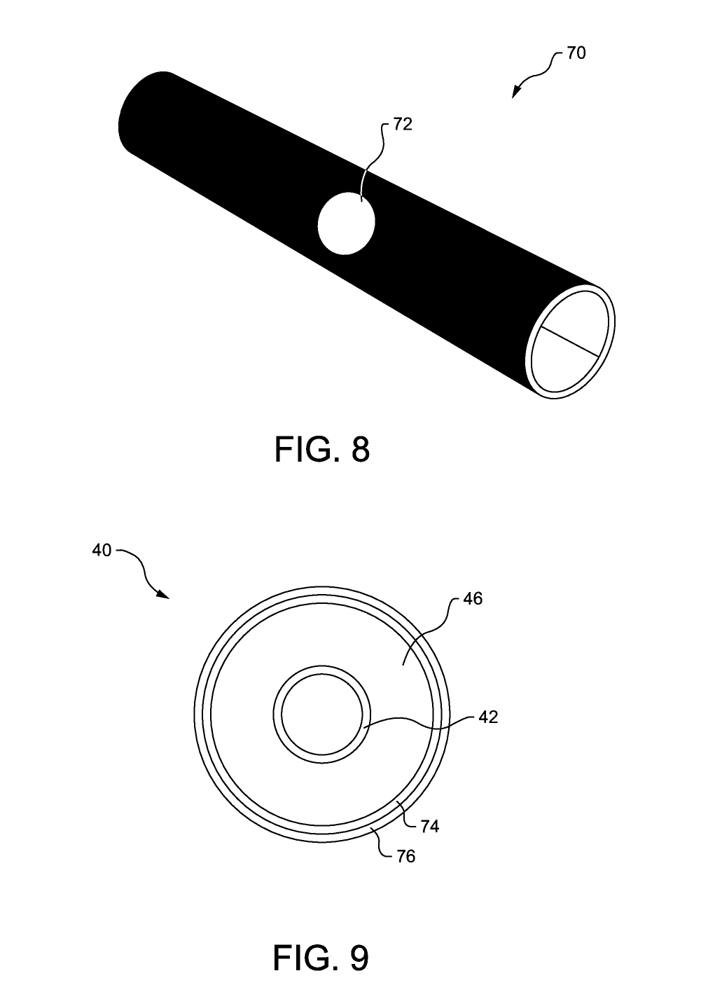

In another example, the protective layer 68 may comprise a sheathing 70, as shown in FIG. 8, that is placed over the carbon fiber 46. The sheathing 70 may include an opening 72 to accommodate the exposure of the end 58 of the protruding member 44. For instance, the sheathing 70 may be provided in a pipe or tube form, although other preformed shapes may be used. To cover the carbon fiber 46, the sheathing 70 may be split into longitudinal halves, placed around the carbon fiber 46, and re-attached. However, other configurations for covering the carbon fiber 46 with the sheathing 70 or protective layer 68 may be used.

In addition, the sheathing 70 may be attached to the interior frame 42, such as via bolting, welding, or other suitable processes. For instance, the sheathing 70 may be attached to the ends 48, 50 of the interior frame 42. In one example, the interior frame 42 may include attachment bosses, and the sheathing 70 may comprise bolt-on steel cladding that encases the carbon fiber 46 and is attached to the interior frame 42 using the attachment bosses. Furthermore, the component 40 may include more than one protective layer 68. For example, as shown in FIG. 9, a nylon protective layer 74 may encase the carbon fiber 46, and a bolt-on steel cladding 76 may encase the nylon protective layer 74. However, other configurations for the protective layers may be used.

### INDUSTRIAL APPLICABILITY

In general, the foregoing disclosure finds utility in various industrial applications, such as, but not limited to, earthmoving, construction, landscaping, mining, agricultural, industrial, transportation, and forestry machines. In particular, the disclosed component may be applied to earth-moving vehicles, excavators, tractors, dozers, loaders, motor graders, backhoes, mining vehicles, on-highway vehicles, trains, agricultural equipment, material handling equipment, and the like.

By applying the disclosed component to a machine, a weight of the components of the machine, and thereby a weight of the machine, may be significantly reduced. The disclosed component provides a lightweight configuration that has a same durability, tensile strength, and ability to attach to other components as a prior art component made entirely out of steel. Furthermore, the disclosed component facilitates an easy method of replacement. More specifically, the disclosed component includes attachment points, such as the ends and the protruding feature, which may be bolted to other machine components. Therefore, if the disclosed component needs to be replaced, it simply has to be unbolted and a new component of the disclosed configuration can be bolted on in its place.

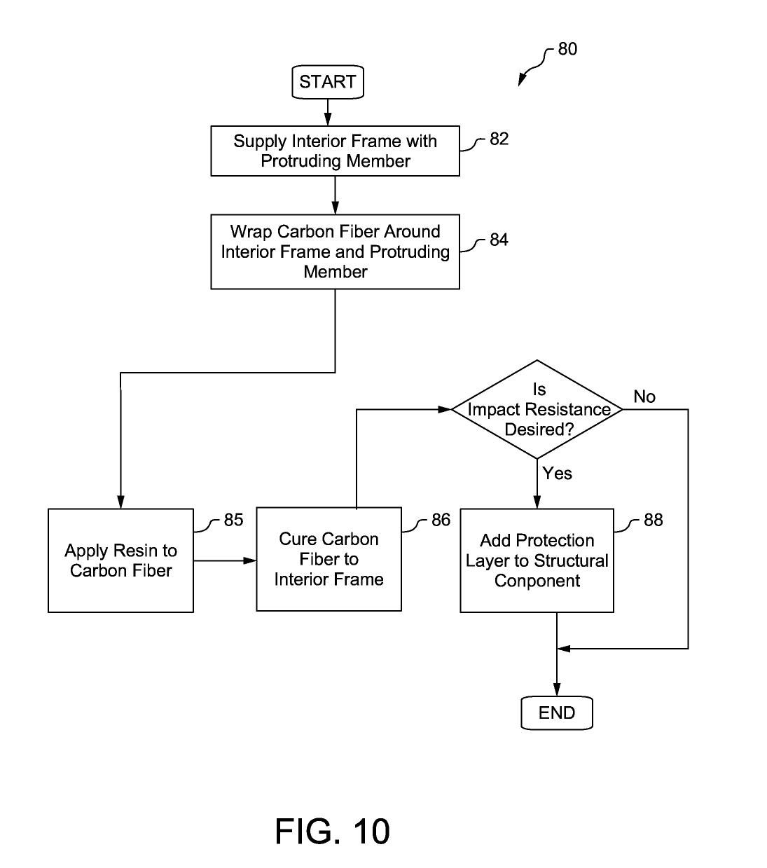

Turning now to FIG. 10, with continued reference to FIGS. 1-9, a flowchart illustrating an example process 80 for manufacturing a structural component for a machine is shown, in accordance with another embodiment. At block 82, an interior frame with a protruding member extending from the interior frame may be supplied. The protruding member may be configured for example, for attachment to another component of the machine. A carbon fiber may be wrapped around the interior frame and the protruding member, at block 84. A hardener and a resin, such as in an epoxy, may be optionally applied to the carbon fiber as it is being wrapped or after it is wrapped around the interior frame and the protruding member as shown at block 85. At block 86, the carbon fiber may be cured to the interior frame. After the carbon fiber is fused to the interior frame, a protective layer for increased protection and impact resistance may be optionally added to the carbon fiber as shown at block 88.

It is to be understood that the flowchart in FIG. 10 is shown and described as an example only to assist in disclosing the features of the disclosed system, and that more or less steps than that shown may be included in the processes corresponding to the various features described above for the disclosed system without departing from the scope of the disclosure.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto. Moreover, while some features are described in conjunction with certain specific embodiments, these features are not limited to use with only the embodiment with which they are described, but instead may be used together with or separate from, other features disclosed in conjunction with alternate embodiments.

What is claimed is:

1. A structural component for a machine, comprising:
an interior frame;
a protruding member extending from the interior frame; and
a carbon fiber wrapped over the interior frame and around the protruding member.

2. The component of claim 1, wherein the interior frame comprises a tubular structure including a wall having a thickness between an inclusive range of approximately three millimeters to six millimeters.

3. The component of claim 1, wherein the interior frame includes at least one end configured for attachment to another component of the machine.

4. The component of claim 1, wherein the protruding member is configured for attachment to another component of the machine.

5. The component of claim 1, wherein the interior frame and the protruding member are each composed of steel.

6. The component of claim 1, wherein the carbon fiber is composed of a single filament wound around the interior frame and the protruding member.

7. The component of claim 1, wherein the carbon fiber is provided in a woven arrangement around the interior frame and the protruding member.

8. The component of claim 1, wherein ends of the interior frame and the protruding member are uncovered by the carbon fiber for attachment to other components of the machine.

9. The component of claim 1, further comprising a sheathing around the carbon fiber to provide protection and impact resistance.

10. The component of claim 9, wherein the sheathing is composed of at least one of nylon and steel.

11. A method of manufacturing a structural component for a machine, comprising:
supplying an interior frame with a protruding member extending from the interior frame;
wrapping a carbon fiber around the interior frame and the protruding member; and
curing the carbon fiber to the interior frame.

12. The method of claim 11, further comprising applying a resin to the carbon fiber as the carbon fiber is being wrapped around the interior frame and the protruding member.

13. The method of claim 11, further comprising applying a resin after a layer of the carbon fiber is wrapped around the interior frame and the protruding member.

14. The method of claim 11, further comprising winding a single filament of the carbon fiber around the interior frame and the protruding member.

15. The method of claim 11, further comprising braiding a plurality of filaments of the carbon fiber as the carbon fiber is being wrapped around the interior frame and the protruding member.

16. The method of claim 11, further comprising applying a pre-woven sleeve of the carbon fiber around the interior frame and the protruding member.

17. The method of claim 11, further comprising supplying a sheathing composed of at least one of steel and nylon over the carbon fiber.

18. The method of claim 11, further comprising three-dimensionally printing a protective layer over the carbon fiber.

19. A machine, comprising:
a machine frame;
a ground engaging member supporting the frame;
a prime mover supported by machine frame; and
at least one structural component forming part of the machine, the structural component including an interior frame having a tubular wall composed of steel, a protruding member extending from the interior frame, the protruding member configured for attachment to another component of the machine, and a carbon fiber wrapped around the interior frame and the protruding member.

20. The machine of claim 19, wherein the at least one structural component is at least one of the machine frame, a linkage, an operator cab, a bracket, and a work tool.
